(19) United States
(12) Patent Application Publication
(10) Pub. No.: US 2006/0289812 A1
(43) Pub. Date: Dec. 28, 2006

(54) OPTOELECTRONIC SEMICONDUCTOR COMPONENT WITH HIGH LIGHT-EMITTING EFFICIENCY

(76) Inventors: Chung-Chan Wu, Taipei City (TW); Chen-Hsiu Lin, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,422

(22) Filed: Feb. 7, 2006

(30) Foreign Application Priority Data
Jun. 23, 2005 (TW) 094120962

(51) Int. Cl. G02B 27/00

(52) U.S. Cl. 250/551

(57) ABSTRACT

An optoelectronic semiconductor component includes a housing including a light exit opening, a first semiconductor chip installed inside the housing for emitting light, and a second semiconductor chip located at a position inside the housing. A distance between the second semiconductor chip and the light exit opening is greater than a distance between the first semiconductor chip and the light exit opening.

### BACKGROUND OF THE INVENTION

1. Field of the Invention

The present invention relates to an optoelectronic semiconductor component with high light-emitting efficiency, and more particularly, to an optoelectronic semiconductor component with a light-emitting diode chip and a semiconductor protective chip wherein the respective distances between the chips and a light exit opening are different so as to increase light-emitting efficiency.

2. Description of the Prior Art

Recently, new application fields of high-illumination light emitting diodes (LEDs) have been developed. Different from a common incandescent light, a cold illumination LED has the advantages of low power consumption, long device lifetime, no idle time, and quick response speed. In addition, since LEDs also have the advantages of small size, vibration resistance, suitability for mass production, and easy fabrication as a tiny device or an array device, they have been widely applied in display apparatuses and indicating lamps of information, communication, and consumer electronics products. LEDs are not only utilized in outdoor traffic signal lamps or various outdoor displays, but also are very important components in the automotive industry. Furthermore, LEDs also work well in portable products, such as cell phones and backlights of personal data assistants. The LED has become a necessary component in the very popular liquid crystal display because it is the best choice for the light source of the backlight module.

Please refer to FIG. 1, FIG. 2, FIG. 3, and FIG. 4. FIG. 1 is a schematic diagram of an optoelectronic semiconductor component 10 in the prior art. FIG. 2 is a front view of the optoelectronic semiconductor component 10 in the prior art. FIG. 3 is a diagram of the optoelectronic semiconductor component 10 fabricated on a circuit board 12 in the prior art. FIG. 4 is a diagram of internal components of the optoelectronic semiconductor component 10 in the prior art. The optoelectronic semiconductor component 10 can be a side-light light emitting diode. The optoelectronic semiconductor component 10 includes a housing 14 including a light exit opening 16, and two frames 18 installed outside the housing 14. Each frame 18 can be an L-shaped frame. Each external electrical contact P1 positioned on a frame 18 is located between the bottom of the frame 18 and the circuit board 12 for receiving external electricity from the circuit board 12. Each frame 18 can be connected to the circuit board 12 by a surface mounting technique.

The optoelectronic semiconductor component 10 further includes a first chip carrier 20, and a second chip carrier 21 installed inside the housing 14. The first chip carrier 20 and the second chip carrier 21 are connected to the two frames 18 respectively. That is, the frames 18 can be extended structures from the first chip carrier 20 and the second chip carrier 21 through the holes on the housing 14. The optoelectronic semiconductor component 10 further includes a first semiconductor chip 22 installed on the first chip carrier 20 for emitting light. The first semiconductor chip 22 can be a light-emitting diode chip. The optoelectronic semiconductor component 10 further includes a second semiconductor chip 24 installed on the first chip carrier 20. The second semiconductor chip 24 can be a semiconductor protective chip for preventing the first semiconductor chip 22 from receiving excessive current, such as a zener diode chip for adjusting working voltage and regulating voltage supplied. The optoelectronic semiconductor component 10 further includes wires 26a, 26b, 26c for electrically connecting the first semiconductor chip 22, the second semiconductor chip 24, the first chip carrier 20, and the second chip carrier 21. The optoelectronic semiconductor component 10 further includes an optical window 28 formed inside the housing 14 and filled with material of changing optical character of light emitted from the first semiconductor chip 22, such as epoxy resin or silica gel. The optical window 28 can include fluorescent material, astigmatic material, or pigment. The optical window 28 is filled with fluid colloid of a transparent material inside the housing 14 and covering the first semiconductor chip 22, the second semiconductor chip 24, and the wires 26a, 26b, 26c. The fluid colloid can be solidified so as to protect and fix the first semiconductor chip 22, the second semiconductor chip 24, and the wires 26a, 26b, 26c.

One disadvantage of this arrangement is that the light emitted from the first semiconductor chip 22 through the optical window 28 to the light exit opening 16 will be sheltered by the second semiconductor chip 24 because the first semiconductor chip 22 and the second semiconductor chip 24 are positioned on the same plane. The light cannot be effectively emitted outside the light exit opening 16 through the optical window 28 by reflection between the internal surface of the housing 14. This reduces the light-emitting uniformity and light-emitting efficiency of the optoelectronic semiconductor component 10.

### SUMMARY OF THE INVENTION

It is therefore a primary objective of the claimed invention to provide an optoelectronic semiconductor component with high light-emitting efficiency for solving the above-mentioned problem.

According to the claimed invention, an optoelectronic semiconductor component includes a housing including a light exit opening, a first semiconductor chip installed inside the housing for emitting light, and a second semiconductor chip located at a position inside the housing. A distance between the second semiconductor chip and the light exit opening is greater than a distance between the first semiconductor chip and the light exit opening.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an optoelectronic semiconductor component in the prior art.

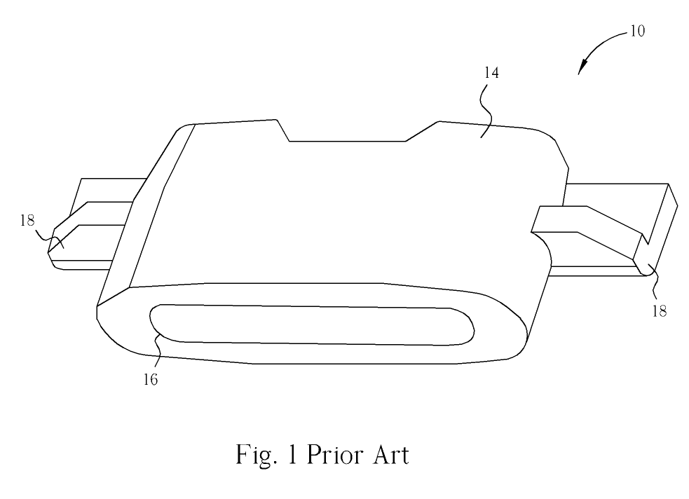

FIG. 2 is a front view of the optoelectronic semiconductor component in the prior art.

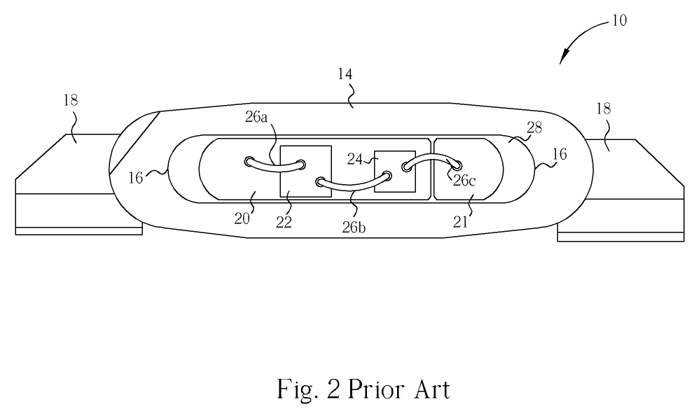

FIG. 3 is a diagram of the optoelectronic semiconductor component fabricated on a circuit board in the prior art.

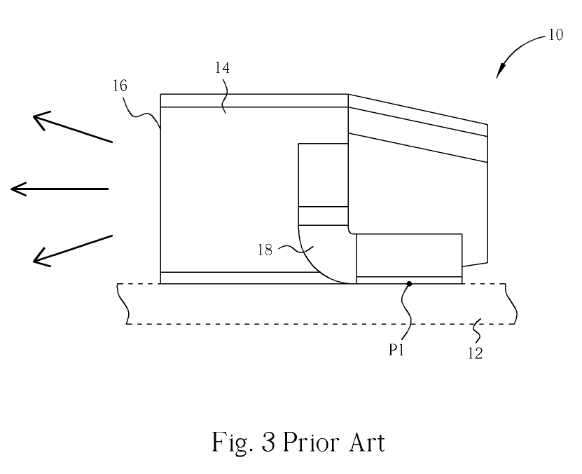

FIG. 4 is a diagram of internal components of the optoelectronic semiconductor component in the prior art.

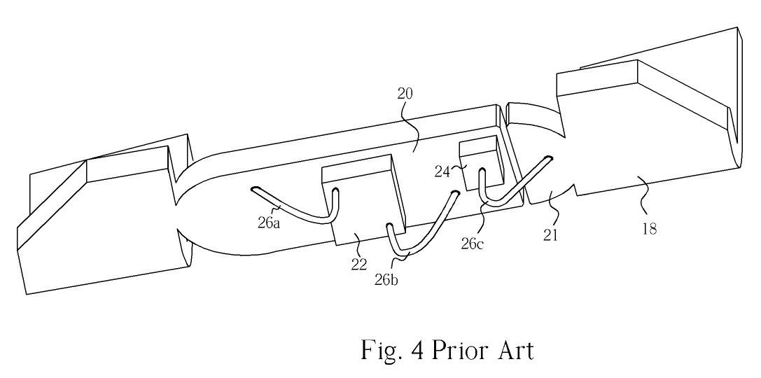

FIG. 5 is a schematic diagram of an optoelectronic semiconductor component according to the present invention.

FIG. 6 is a front view of the optoelectronic semiconductor component according to the present invention.

FIG. 7 is a diagram of the optoelectronic semiconductor component fabricated on a circuit board according to the present invention.

FIG. 8 is a cutaway view of the optoelectronic semiconductor component according to the present invention.

FIG. 9 is a diagram of internal components of the optoelectronic semiconductor component according to the present invention.

FIG. 10 is a cutaway view of an optoelectronic semiconductor component of another embodiment according to the present invention.

### DETAILED DESCRIPTION

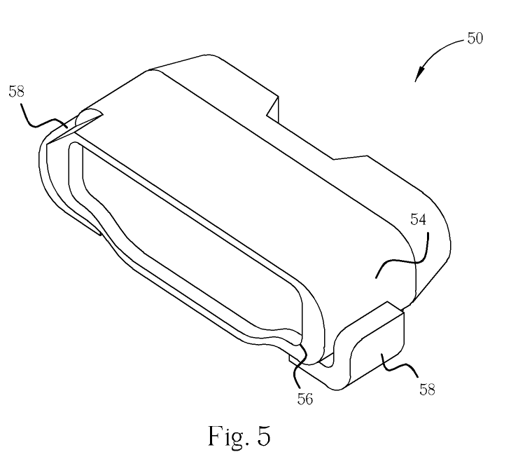

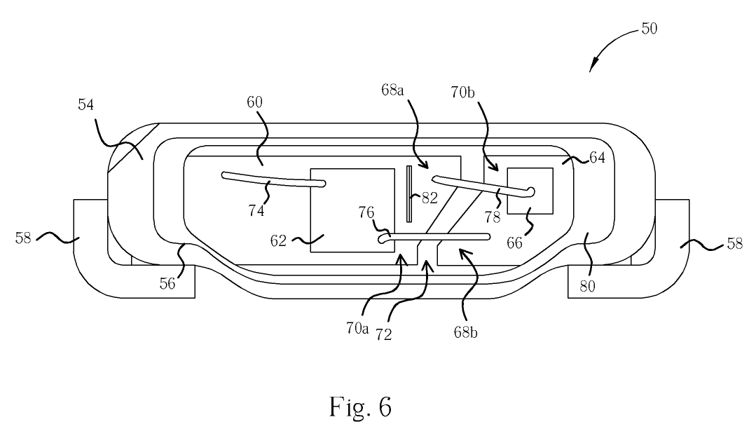

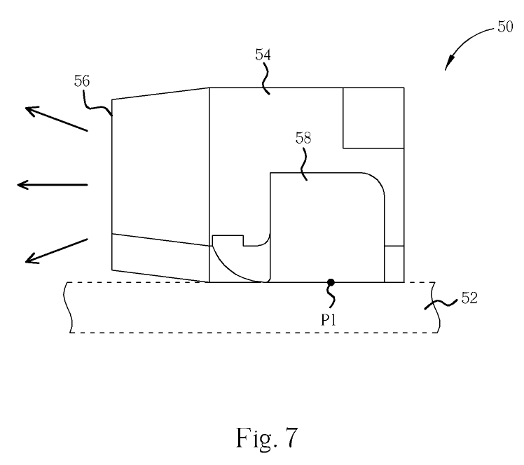

Please refer to FIG. 5, FIG. 6, and FIG. 7. FIG. 5 is a schematic diagram of an optoelectronic semiconductor component 50 according to the present invention. FIG. 6 is a front view of the optoelectronic semiconductor component 50 according to the present invention. FIG. 7 is a diagram of the optoelectronic semiconductor component 50 fabricated on a circuit board 52 according to the present invention. The optoelectronic semiconductor component 50 can be a side-light light emitting diode. The optoelectronic semiconductor component 50 includes a housing 54 including a light exit opening 56, and two frames 58 installed outside the housing 54. Each frame 58 can be an L-shaped frame. Each external electrical contact P1 positioned on a frame 58 is located between the bottom of the frame 58 and the circuit board 52 for receiving external electricity from the circuit board 52. Each frame 58 can be connected to the circuit board 52 by a surface mounting technique.

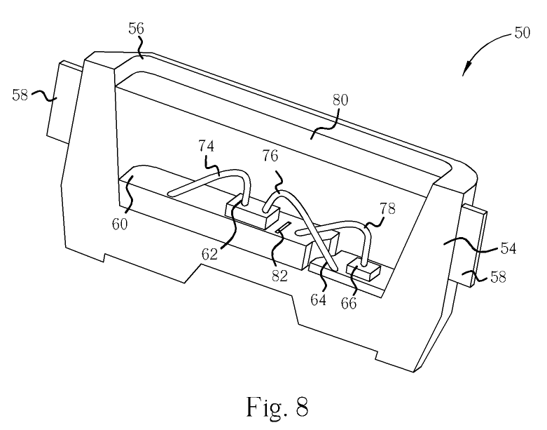

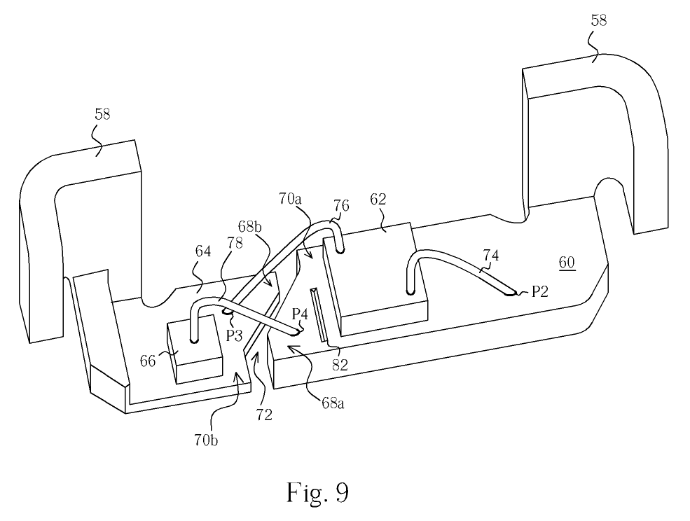

Please refer to FIG. 8 and FIG. 9. FIG. 8 is a cutaway view of the optoelectronic semiconductor component 50 according to the present invention. FIG. 9 is a diagram of internal components of the optoelectronic semiconductor component 50 according to the present invention. The optoelectronic semiconductor component 50 further includes a first chip carrier 60 installed inside the housing 54. The first chip carrier 60 is connected to the frame 58. That is, the frame 58 can be an extended structure from the first chip carrier 60 through the hole on the housing 54 so as to form an electrical contact for receiving external electricity provided by the circuit board 52. The optoelectronic semiconductor component 50 further includes a first semiconductor chip 62 installed on the first chip carrier 60 for emitting light. The first semiconductor chip 62 can be a light-emitting diode chip. An adhesive made of insulating material, such as silver glue, can be applied between the first chip carrier 60 and the first semiconductor chip 62. The optoelectronic semiconductor component 50 further includes a second chip carrier 64 located in a position inside the housing 54 wherein the distance between the second chip carrier 64 and the light exit opening 56 is greater than the distance between the first chip carrier 60 and the light exit opening 56. That is, a height difference exists between the first chip carrier 60 and the second chip carrier 64 with respect to the light exit opening 56. Similarly, the second chip carrier 64 is connected to the other frame 58. That is, the other frame 58 can be an extended structure from the second chip carrier 64 through the hole on the housing 54 so as to form an electrical contact for receiving external electricity provided by the circuit board 52. The optoelectronic semiconductor component 50 further includes a second semiconductor chip 66 installed on the second chip carrier 64. The second semiconductor chip 66 can be a semiconductor protective chip for preventing the first semiconductor chip 62 from receiving excessive current, such as a zener diode chip for adjusting working voltage and regulating voltage supplied. An adhesive made of electricity-conducting material, such as electricity-conducting glue, can be applied between the second chip carrier 64 and the second semiconductor chip 66 so as to connect the second chip carrier 64 and the second semiconductor chip 66 electrically.

A first broad area 68a and a first narrow area 70a are formed on the first chip carrier 60 between the first semiconductor chip 62 and the second chip carrier 64. A second broad area 68b and a second narrow area 70b are formed on the second chip carrier 64 between the second semiconductor chip 66 and the first chip carrier 60. An oblique gap 72 exists between the first chip carrier 60 and the second chip carrier 64 so as to form the first broad area 68a and the first narrow area 70a on the first chip carrier 60 and the second broad area 68b and a second narrow area 70b on the second chip carrier 64. The optoelectronic semiconductor component 50 further includes a first wire 74 electrically connected to the first semiconductor chip 62 and a first electrical contact P2 on the first chip carrier 60, a second wire 76 electrically connected to the first semiconductor chip 62 and a second electrical contact P3 on the second chip carrier 64, and a third wire 78 electrically connected to the second semiconductor chip 66 and a third electrical contact P4 on the first chip carrier 60. The second electrical contact P3 is positioned on the second broad area 68b, and the third electrical contact P4 is positioned on the first broad area 68a. The first semiconductor chip 62 and the second semiconductor chip 66 can be electrically connected to the frames 58 for receiving electricity from the circuit board 52 via the electrical connection between the first wire 74 and the first chip carrier 60, the electrical connection between the second wire 76 and the second chip carrier 64, the electrical connection between the third wire 78 and the first chip carrier 60, and the electrical connection between the second semiconductor chip 66 and the second chip carrier 64. An end of the second wire 76 can be soldered to the second electrical contact P3 on the second broad area 68b and an end of the third wire 78 can be soldered to the third electrical contact P4 on the first broad area 68a so as to enlarge soldering area and reduce soldering difficulty.

The optoelectronic semiconductor component 50 further includes an optical window 80 formed inside the housing 54 and filled with material having the property of changing the optical character of light emitted from the first semiconductor chip 62, such as epoxy resin or silica gel. The optical window 80 can include fluorescent material, astigmatic material, or pigment. The optical window 80 is filled with fluid colloid of a transparent material inside the housing 54 and covering the first semiconductor chip 62, the second semiconductor chip 66, the first wire 74, the second wire 76, and the third wire 78. The fluid colloid is then solidified so as to protect and fix the first semiconductor chip 62, the second semiconductor chip 66, the first wire 74, the second wire 76, and the third wire 78. A groove 82 is formed on the first chip carrier 60. The groove 82 can be a V-shaped groove. When adhesive applied on the bottom of the first semiconductor chip 62 to attach the first semiconductor chip 62 to the first chip carrier 60 escapes from the interface between the first semiconductor chip 62 and the first chip carrier 60, the groove 82 can contain the runoff adhesive so as to prevent the adhesive from contacting the third wire 78.

In conclusion, there is a height difference between the first chip carrier 60 and the second chip carrier 64, and the distance between the second chip carrier 64 and the light exit opening 56 is greater than the distance between the first chip carrier 60 and the light exit opening 56. That is, the first semiconductor chip 62 and the second semiconductor chip 66 are not positioned on the same plane. The light emitted from the first semiconductor chip 62 will not be blocked by the second semiconductor chip 66. The light emitted from the first semiconductor chip 62 can pass through the optical window 80 to the light exit opening 56 directly or be reflected out from the light exit opening 56 by the internal surface of the housing 54 so as to increase the light-emitting uniformity and light-emitting efficiency of the optoelectronic semiconductor component 50. Chips with different functions can be embedded inside the optoelectronic semiconductor component 50 of the present invention. For instance, a zener diode chip or light-emitting diode chips can be used for emitting light of different wavelengths (380 nm-700 nm), so as to increase the flexibility of application of the optoelectronic semiconductor component. For example, light-emitting efficiency cannot be reduced when embedding zener diode chip for increasing antistatic ability of the optoelectronic semiconductor component or when embedding light-emitting diode chips for emitting light of wavelengths 600 nm-640 nm so as to increase the color rendering property of the optoelectronic semiconductor component.

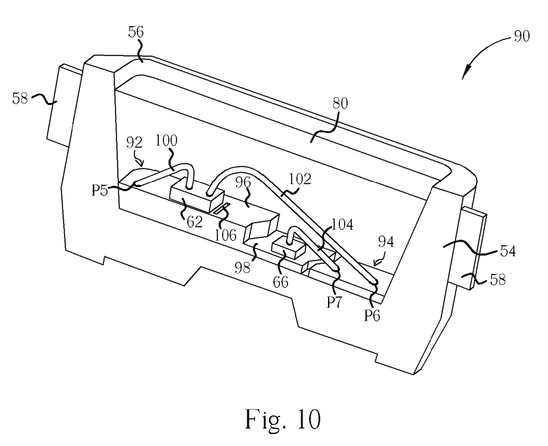

However, the first semiconductor chip 62 and the second semiconductor chip 66 can be positioned on the same chip carrier. Please refer to FIG. 10, which is a cutaway view of an optoelectronic semiconductor component 90 of another embodiment according to the present invention. Please note that elements with the same reference numerals are substantially the same through the various embodiments. The difference between the optoelectronic semiconductor component 90 and the optoelectronic semiconductor component 50 is that the first semiconductor chip 62 and the second semiconductor chip 66 of the optoelectronic semiconductor component 90 are positioned on the same chip carrier, while the first semiconductor chip 62 and the second semiconductor chip 66 of the optoelectronic semiconductor component 50 are positioned on the first chip carrier 60 and the second chip carrier 64 respectively. The optoelectronic semiconductor component 90 further includes a third chip carrier 92 installed inside the housing 54. Similar to the previous embodiment, the third chip carrier 92 is connected to the frame 58. That is, the frame 58 can be an extended structure from the third chip carrier 92 through the hole on the housing 54 so as to form an electrical contact for receiving external electricity provided by the circuit board 52. The optoelectronic semiconductor component 90 further includes a connecting structure 94 installed inside the housing 54. Similar to the third chip carrier 92, the connecting structure 94 is connected to the other frame 58. That is, the other frame 58 can be an extended structure from the connecting structure 94 through the hole on the housing 54 so as to form an electrical contact for receiving external electricity provided by the circuit board 52. The third chip carrier 92 includes a first surface 96 for carrying the first semiconductor chip 62 and a second surface 98 located at a position for carrying the second semiconductor chip 66. A distance between the second surface 98 and the light exit opening 56 is greater than a distance between the first surface 96 and the light exit opening 56. That is, a height difference exists between the first semiconductor chip 62 and the second semiconductor chip 66 with respect to the light exit opening 56. An adhesive made of electricity-conducting material, such as electricity-conducting glue, can be applied between the second surface 98 of the third chip carrier 92 and the second semiconductor chip 66 so as to electrically connect the third chip carrier 92 and the second semiconductor chip 66.

The optoelectronic semiconductor component 90 further includes a fourth wire 100 electrically connected to the first semiconductor chip 62 and a fourth electrical contact P5 on the third chip carrier 92, a fifth wire 102 electrically connected to the first semiconductor chip 62 and a fifth electrical contact P6 on the connecting structure 94, and a sixth wire 104 electrically connected to the second semiconductor chip 66 and a sixth electrical contact P7 on the connecting structure 94. The first semiconductor chip 62 and the second semiconductor chip 66 can be electrically connected to the frames 58 for receiving electricity from the circuit board 52 via the electrical connection between the fourth wire 100 and the third chip carrier 92, the electrical connection between the fifth wire 102 and the connecting structure 94, the electrical connection between the sixth wire 104 and the connecting structure 94, and the electrical connection between the second semiconductor chip 66 and the third chip carrier 92. Similar to the previous embodiment, a groove 106 is formed on the third chip carrier 92. The groove 106 can be a V-shaped groove. When adhesive, applied to the bottom of the first semiconductor chip 62 to attach the first semiconductor chip 62 to the third chip carrier 92, escapes from the interface between the first semiconductor chip 62 and the third chip carrier 92, the groove 106 can contain the runoff adhesive so as to prevent the adhesive from contacting the wires.

In conclusion, there is a height difference between the first surface 96 and the second surface 98 on the third chip carrier 92 with respect to the light exit opening 56, and the distance between the second surface 98 and the light exit opening 56 is greater than the distance between the first surface 96 and the light exit opening 56. That is, the first semiconductor chip 62 and the second semiconductor chip 66 are not positioned on the same plane. The light emitted from the first semiconductor chip 62 will not be blocked by the second semiconductor chip 66. The light emitted from the first semiconductor chip 62 can pass through the optical window 80 to the light exit opening 56 directly or be reflected out from the light exit opening 56 by the internal surface of the housing 54 so as to increase the light-emitting uniformity and light-emitting efficiency of the optoelectronic semiconductor component 90. Chips with different functions can be embedded inside the optoelectronic semiconductor component 90 of the present invention. Such chips can include a zener diode chip or light-emitting diode chips for emitting light of different wavelengths (380 nm-700 nm), so as to increase the flexibility of application of the optoelectronic semiconductor component. For example, light-emitting efficiency cannot be reduced when embedding a zener diode chip for increasing antistatic ability of the optoelectronic semiconductor component or when embedding light-emitting diode chips for emitting light of wavelengths 600 nm-645 nm) so as to increase the color rendering property of the optoelectronic semiconductor component. Furthermore, in this embodiment, there is no need to form broad areas and narrow areas on the third chip carrier 92 and the connecting structure 94 respectively because the first semiconductor chip 62 and the second semiconductor chip 66 are positioned on the same chip carrier. The width of the third chip carrier 92 and the width of the connecting structure 94 can be reduced so as to reduce the thickness of the optoelectronic semiconductor component 90. The optoelectronic semiconductor component 90 can have a small size so that it can be applied to small portable electronic appliances, such as mobile phones, PDAs, and so on.

In contrast to the conventional optoelectronic semiconductor component, the optoelectronic semiconductor component according to the present invention includes a light-emitting diode chip and a semiconductor protective chip. The respective distances between the chips and a light exit opening are different. Hence, light emitted from the light-emitting diode chip will not be blocked by the semiconductor protective chip, thereby increasing the light-emitting uniformity and light-emitting efficiency of the optoelectronic semiconductor component.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optoelectronic semiconductor component comprising:
a housing comprising a light exit opening;
a first semiconductor chip installed inside the housing for emitting light; and
a second semiconductor chip located at a position inside the housing, wherein a distance between the second semiconductor chip and the light exit opening is greater than a distance between the first semiconductor chip and the light exit opening.

2. The optoelectronic semiconductor component of claim 1 further comprising:
a first chip carrier installed inside the housing for carrying the first semiconductor chip; and
a second chip carrier located at a position inside the housing for carrying the second semiconductor chip, wherein a distance between the second chip carrier and the light exit opening is greater than a distance between the first chip carrier and the light exit opening.

3. The optoelectronic semiconductor component of claim 2 further comprising:
a first wire electrically connected to the first semiconductor chip and a first electrical contact on the first chip carrier;
a second wire electrically connected to the first semiconductor chip and a second electrical contact on the second chip carrier; and
a third wire electrically connected to the second semiconductor chip and a third electrical contact on the first chip carrier.

4. The optoelectronic semiconductor component of claim 3 wherein a first broad area and a first narrow area are formed on the first chip carrier between the first semiconductor chip and the second chip carrier, a second broad area and a second narrow area are formed on the second chip carrier between the second semiconductor chip and the first chip carrier, the second electrical contact is positioned on the second broad area, and the third electrical contact is positioned on the first broad area.

5. The optoelectronic semiconductor component of claim 2 wherein a groove is formed on the first chip carrier.

6. The optoelectronic semiconductor component of claim 5 wherein the groove is a V-shaped groove.

7. The optoelectronic semiconductor component of claim 2 further comprising two frames installed outside the housing, one frame connected to the first chip carrier and another frame connected to the second chip carrier, wherein an external electrical contact is positioned on each of the two frames for receiving external electricity.

8. The optoelectronic semiconductor component of claim 7 wherein the frames are connected to a circuit board by a surface mounting technique.

9. The optoelectronic semiconductor component of claim 1 further comprising:
a third chip carrier installed inside the housing, the third chip carrier comprising a first surface for carrying the first semiconductor chip and a second surface located at a position for carrying the second semiconductor chip, wherein a distance between the second surface and the light exit opening is greater than a distance between the first surface and the light exit opening.

10. The optoelectronic semiconductor component of claim 9 further comprising:
a connecting structure installed inside the housing;
a fourth wire electrically connected to the first semiconductor chip and a fourth electrical contact on the third chip carrier;
a fifth wire electrically connected to the first semiconductor chip and a fifth electrical contact on the connecting structure; and
a sixth wire electrically connected to the second semiconductor chip and a sixth electrical contact on the connecting structure.

11. The optoelectronic semiconductor component of claim 9 wherein a groove is formed on the first surface of third chip carrier.

12. The optoelectronic semiconductor component of claim 11 wherein the groove is a V-shaped groove.

13. The optoelectronic semiconductor component of claim 10 further comprising two frames installed outside the housing, one frame connected to the third chip carrier and another frame connected to the connecting structure, wherein an external electrical contact is positioned on each of the two frames for receiving external electricity.

14. The optoelectronic semiconductor component of claim 13 wherein the frames are connected to a circuit board by a surface mounting technique.

15. The optoelectronic semiconductor component of claim 1 further comprising an optical window formed inside the housing and filled with material capable of changing optical character of light emitted from the first semiconductor chip.

16. The optoelectronic semiconductor component of claim 15 wherein the material is epoxy resin or silica gel.

17. The optoelectronic semiconductor component of claim 15 wherein the optical window comprises fluorescent material, astigmatic material, or pigment.

18. The optoelectronic semiconductor component of claim 1 wherein the first semiconductor chip is a light-emitting diode chip.

19. The optoelectronic semiconductor component of claim 1 wherein the second semiconductor chip is a semiconductor protective chip.

20. The optoelectronic semiconductor component of claim 19 wherein the semiconductor protective chip is a zener diode chip.
